(19) United States
(12) Patent Application Publication
(10) Pub. No.: US 2025/0370570 A1
(43) Pub. Date: Dec. 4, 2025

(54) TOUCH DEVICE AND TOUCH SENSING METHOD

(71) Applicant: Novatek Microelectronics Corp., Hsinchu (TW)

(72) Inventors: Yi-Ying Lin, Hualien County (TW); Chih-Chang Lai, Taichung City (TW); Che-Chia Hsu, Hsinchu City (TW)

(73) Assignee: Novatek Microelectronics Corp., Hsinchu (TW)

(21) Appl. No.: 18/677,908

(22) Filed: May 30, 2024

(51) Int. Cl. G06F 3/041

(52) U.S. Cl. CPC G06F 3/04186; G06F 2203/04104

(57) ABSTRACT

A touch device including a touch panel and an electronic circuit is provided. The touch panel is configured to detect a touch event of at least two objects. The at least two objects are coupled to different signal sources. The electronic circuit is coupled to the touch panel. The electronic circuit is configured to distinguish touch operations of the at least two objects according to the signal sources.

### BACKGROUND

### Technical Field

The invention relates to an electronic device and a sensing method, more specifically, to a touch device and a touch sensing method.

### Description of Related Art

Touch systems are capable of sensing all capacitance changes that occur in the touch panel or touch pad. The amount of capacitance changes is then used to calculate and report the corresponding touch position. If there are more than two touch operations, it's not clear if the capacitance changes are from the same user or different users. Some gestures might be misjudged. For example, if two users perform two-finger zoom-in/zoom-out gestures at the same time, it might be misjudged.

### SUMMARY

The invention is directed to a touch device and a touch sensing method, capable of reducing misjudgment of gestures of different objects.

An embodiment of the invention provides a touch device, including a touch panel and an electronic circuit. The touch panel is configured to detect a touch event of at least two objects. The at least two objects are coupled to different signal sources. The electronic circuit is coupled to the touch panel. The electronic circuit is configured to distinguish touch operations of the at least two objects according to the signal sources.

An embodiment of the invention provides a touch sensing method, including: detecting a touch event of at least two objects, wherein the at least two objects are coupled to different signal sources; and distinguishing touch operations of the at least two objects according to the signal sources.

In an embodiment of the invention, the touch event of at least two objects indicates the at least two objects touch the touch panel at a same time.

In an embodiment of the invention, the signal sources have two different frequencies.

In an embodiment of the invention, the signal sources have two different phases.

In an embodiment of the invention, a phase of one of the signal sources is constant, and a phase of the other of the signal sources is variable.

In an embodiment of the invention, one of the signal sources is a direct current (DC) signal source, and the other of the signal sources is an alternating current (AC) signal source.

In an embodiment of the invention, the at least two objects directly touch the touch panel without styluses.

In order for the features and advantages of the disclosure to be more comprehensible, the following specific embodiments are described in detail in conjunction with the drawings.

### BRIEF DESCRIPTION OF THE DRAWINGS

FIG. 1 is a block diagram illustrating a touch device according to an embodiment of the invention.

FIG. 2 is a schematic diagram illustrating an application scenario of the touch device of FIG. 1.

FIG. 3 is a schematic diagram illustrating touch operations performed on the touch panel of FIG. 1.

FIG. 4 is a schematic diagram illustrating signal characteristics according to an embodiment of the invention.

FIG. 5 is a schematic diagram illustrating signal characteristics according to another embodiment of the invention.

FIG. 6 is a schematic diagram illustrating signal characteristics according to another embodiment of the invention.

FIG. 7 is a schematic diagram illustrating a first application scenario of the touch device according to an embodiment of the invention.

FIG. 8 is a schematic diagram illustrating a second application scenario of the touch device according to an embodiment of the invention.

FIG. 9 is a schematic diagram illustrating a third application scenario of the touch device according to an embodiment of the invention.

FIG. 10 is a schematic diagram illustrating a fourth application scenario of the touch device according to an embodiment of the invention.

FIG. 11 is a flowchart illustrating steps in a touch sensing method according to an embodiment of the invention.

### DETAILED DESCRIPTION OF DISCLOSED EMBODIMENTS

The term “coupling (or connection)” used in the entire specification (including the claims) of the disclosure may refer to any direct or indirect connection means. For example, if a first device is described as being coupled (or connected) to a second device, it should be interpreted that the first device may be directly connected to the second device or the first device may be indirectly connected to the second device through another device or certain connection means. Terms such as “first” and “second” mentioned in the entire specification (including the claims) of the disclosure are used to name the elements or to distinguish between different embodiments or ranges, but not to limit the upper limit or the lower limit of the number of elements or to limit the sequence of the elements. In addition, wherever possible, elements/components/steps using the same reference numerals in the drawings and the implementation manners represent the same or similar parts. Related descriptions of the elements/components/steps using the same reference numerals or using the same terminologies in different embodiments may be cross-referenced.

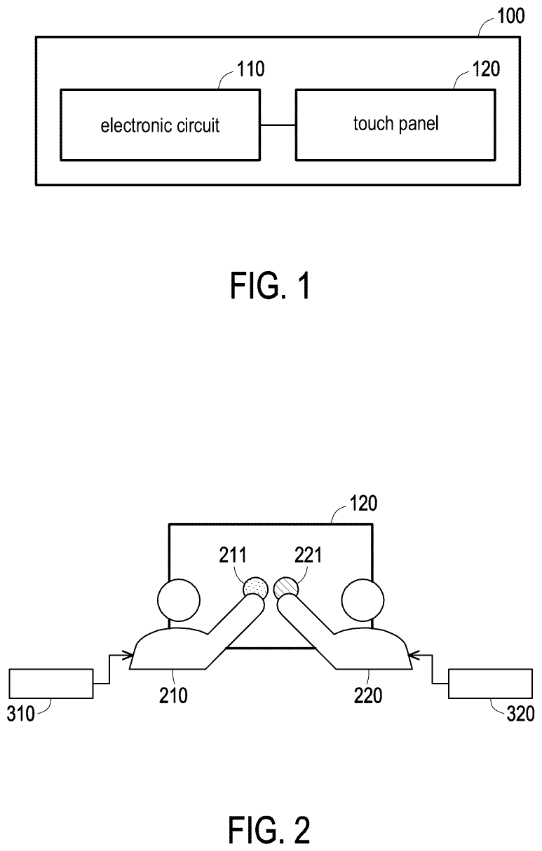

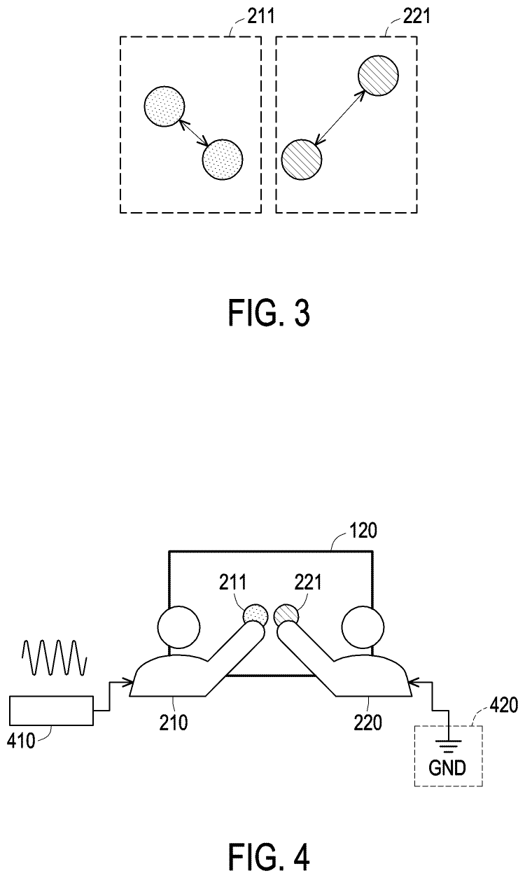

FIG. 1 is a block diagram illustrating a touch device according to an embodiment of the invention. FIG. 2 is a schematic diagram illustrating an application scenario of the touch device of FIG. 1. FIG. 3 is a schematic diagram illustrating touch operations performed on the touch panel of FIG. 1. Referring to FIG. 1 to FIG. 3, the touch device 100 includes an electronic circuit 110 and a touch panel 120. The touch panel 120 includes touch sensors. The electronic circuit 110 is configurable to be coupled to the touch panel 120. The electronic circuit 110 is configured to drive the touch panel 120 to perform a touch sensing function.

To be specific, the touch panel 120 is configured to detect a touch event of two objects 210 and 220, such as two users. The users 210 and 220 may directly touch the touch panel 120 without styluses. The two objects 210 and 220 are coupled to different signal sources 310 and 320. The touch event indicates the two objects 210 and 220 touch the touch panel 120 at the same time, and thus, touch operations 211 and 221 are performed on the touch panel 120. The touch operations 211 and 221 may include zoom in or zoom out gestures, and the type of gestures is not intended to limit the invention. The electronic circuit 110 can distinguish touch operations 211 and 221 of the two objects 210 and 220 according to the signal sources 310 and 320.

Therefore, when the two users 210 and 220 perform zoom in or zoom out gestures at the same time, The electronic circuit 110 can distinguish the two users according to signal characteristics before determining the touch behavior. The signal characteristics may include frequency, phase and/or type, e.g. DC or AC. This means that if there are more than two contacts, it can be determined whether the change in capacitance is from the same user or from different users. As a result, misjudgment of gestures of different objects can be reduced.

In an embodiment, the touch device 100 may be an electronic device having a display function and a touch sensing function. In an embodiment, the touch device 100 may be, but not limited to, a smartphone, a non-smart phone, a wearable electronic device, a tablet computer, a personal digital assistant, a notebook and other portable electronic devices that can operate independently and have the display function, the touch sensing function and the fingerprint sensing function. In an embodiment, the touch device 100 may be, but not limited to, a portable or un-portable electronic device in a vehicle intelligent system. In an embodiment, the touch device 100 may be, but not limited to, intelligent home appliances such as, a television, a computer, a refrigerator, a washing machine, a telephone, an induction cooker, a table lamp and so on.

In an embodiment, the electronic circuit 110 may be implemented as a single chip integrated circuit that can drive and control the touch panel 120 to perform the display operation and the touch sensing operation. The electronic circuit 110 may include a control circuit, and the control circuit may be a micro-controller based core to perform all of control activities of the display operation and the touch sensing operation. The control circuit may include at least one of a timing controller and a touch controller.

In an embodiment, the electronic circuit 110 may be a processor having computational capability. Alternatively, the electronic circuit 110 may be designed through hardware description languages (HDL) or any other design methods for digital circuits familiar to people skilled in the art and may be hardware circuits implemented through a field programmable gate array (FPGA), a complex programmable logic device (CPLD), or an application-specific integrated circuit (ASIC). In addition, enough teaching, suggestion, and implementation illustration for hardware structures of the electronic circuit 110 can be obtained with reference to common knowledge in the related art, which is not repeated hereinafter.

FIG. 4 is a schematic diagram illustrating signal characteristics according to an embodiment of the invention. Referring to FIG. 4, the object 210 is coupled to a signal source 410 of AC, and the object 220 is coupled to a signal source 420 of DC, e.g. a ground voltage GND. That is to say, one of the signal sources 410 and 420 is a DC signal source, and the other of the signal sources 410 and 420 is an AC signal source.

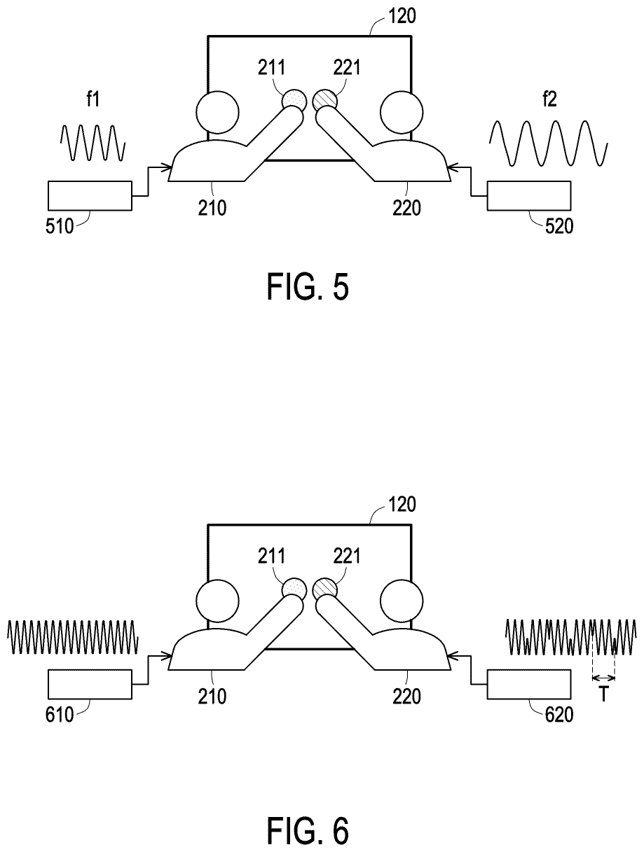

FIG. 5 is a schematic diagram illustrating signal characteristics according to another embodiment of the invention. Referring to FIG. 5, signal sources 510 and 520 have two different frequencies f1 and f2. The object 210 is coupled to the signal source 510 of the frequency f1, and the object 220 is coupled to the signal source 520 of the frequency f2, wherein the frequency f1 is different from the frequency f2.

FIG. 6 is a schematic diagram illustrating signal characteristics according to another embodiment of the invention. Referring to FIG. 6, signal sources 610 and 620 have two different phases but the same frequency. The object 210 is coupled to the signal source 610, and the object 220 is coupled to the signal source 620. For example, the phase of the signal source 610 is constant, and the phase of the signal source 620 is variable. The phase of the signal source 620 is changed by 180 degrees for each time period T.

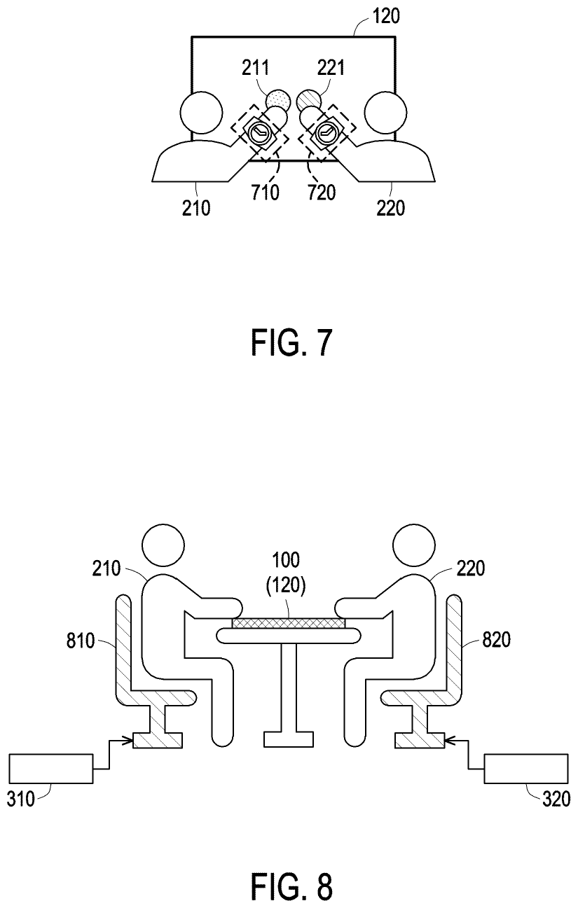

FIG. 7 is a schematic diagram illustrating a first application scenario of the touch device according to an embodiment of the invention. Referring to FIG. 7, the touch device 100 is a tablet for learning, and the watches 710 and 720 are as signal sources. Stable signals can be coupled to the users via portable devices or devices that can be stably contacted. All users 210 and 220 can operate the touch device 100 simultaneously, but the instructor has priority. In addition, the users 210 and 220 may have corresponding track colors that can be directly marked on the touch panel 120 to clearly distinguish users.

FIG. 8 is a schematic diagram illustrating a second application scenario of the touch device according to an embodiment of the invention. Referring to FIG. 8, the touch device 100 is a tablet for meeting room, and the seats 810 and 820 are as signal transmission paths. The seats 810 and 820 can serve as devices that can be stably contacted with the users 210 and 220, and signals from the signal sources 310 and 320 can be coupled to the users 210 and 220 via the seats 810 and 820. All users 210 and 220 can operate the touch device 100 simultaneously, but the reporter has priority. In addition, the users 210 and 220 may have corresponding track colors that can be directly marked on the touch panel 120 to clearly distinguish users.

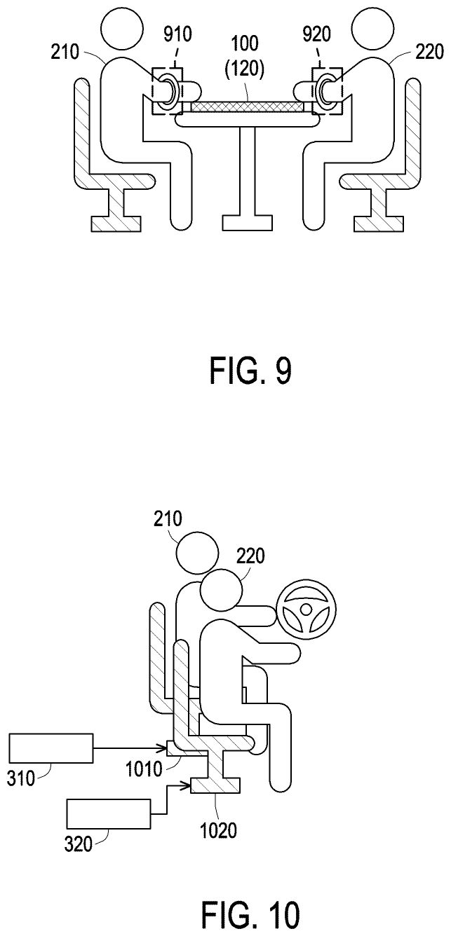

FIG. 9 is a schematic diagram illustrating a third application scenario of the touch device according to an embodiment of the invention. Referring to FIG. 9, the touch device 100 is a tablet for gaming, and the wristbands 910 and 920 are as signal sources.

FIG. 10 is a schematic diagram illustrating a fourth application scenario of the touch device according to an embodiment of the invention. Referring to FIG. 10, the touch device 100 may be embedded in vehicle cockpit systems. Floor mats, seat cushions, or objects 1010 and 1020 in stable contact with the driver 210 and the passenger 220 can serve as signal transmission paths. The signal sources 310 and 320 can provide signals through the above signal transmission paths 1010 and 1020 to the driver 210 and the passenger 220. In vehicle cockpit systems, items displayed on the touch panel 120 for the driver 210 are not available to the passenger 220. Alternatively, items displayed on the touch panel 120 that would affect driving safety are not available to the driver 210.

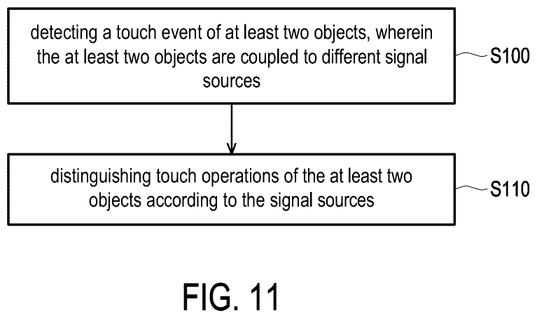

FIG. 11 is a flowchart illustrating steps in a touch sensing method according to an embodiment of the invention. Referring to FIG. 1 and FIG. 11, the touch sensing method is at least adapted to the electronic device 100 depicted in FIG. 1, but the invention is not limited thereto. Taking the electronic device 100 for example, in step S100, the touch panel 120 detects a touch event of at least two objects, wherein the at least two objects are coupled to different signal sources. In step S110, the electronic circuit 110 distinguishes touch operations of the at least two objects according to the signal sources.

The touch sensing method described in the embodiment of the invention is sufficiently taught, suggested, and embodied in the embodiments illustrated in FIG. 1 to FIG. 10, and therefore no further description is provided herein.

In summary, in the embodiments of the invention, external signals, such as specified frequencies or ground voltages, are coupled to users. When a touch event occurs, the coupling signals transmitted from the users to the touch panel to identify the touch operations. If there are more than two touch operations, it can be recognized that the capacitance changes are from the same user or different users. Gestures are not misjudged. For example, if two users perform similar gestures at the same time, the coupling signals can be used to distinguish the touch operations. This can be used for user-specific applications, such as priority, permission setting, or specified behaviors.

Although the disclosure has been disclosed in the embodiments, the embodiments are not intended to limit the disclosure. Persons skilled in the art may make some changes and modifications without departing from the spirit and scope of the disclosure. Therefore, the protection scope of the disclosure shall be defined by the appended claims.

1. A touch device, comprising:
a touch panel, configured to detect a touch event of at least two objects, wherein the at least two objects are coupled to different signal sources; and
an electronic circuit, coupled to the touch panel, and configured to distinguish touch operations of the at least two objects according to the signal sources,
wherein the touch event of at least two objects indicates the at least two objects touch the touch panel at a same time,
wherein one of the at least two objects has a higher priority of operation,
wherein the signal sources have two different phases,
wherein a phase of one of the signal sources is constant, and a phase of the other of the signal sources is variable.

2. (canceled)

3. The touch device according to claim 1, wherein the signal sources have two different frequencies.

4. (canceled)

5. (canceled)

6. The touch device according to claim 1, wherein one of the signal sources is a direct current (DC) signal source, and the other of the signal sources is an alternating current (AC) signal source.

7. The touch device according to claim 1, wherein the at least two objects directly touch the touch panel without styluses.

8. A touch sensing method, comprising:
detecting a touch event of at least two objects, wherein the at least two objects are coupled to different signal sources; and
distinguishing touch operations of the at least two objects according to the signal sources,
wherein the touch event of at least two objects indicates the at least two objects touch the touch panel at a same time,
wherein one of the at least two objects has a higher priority of operation,
wherein the signal sources have two different phases,
wherein a phase of one of the signal sources is constant, and a phase of the other of the signal sources is variable.

9. (canceled)

10. The touch sensing method according to claim 8, wherein the signal sources have two different frequencies.

11. (canceled)

12. (canceled)

13. The touch sensing method according to claim 8, wherein one of the signal sources is a DC signal source, and the other of the signal sources is an AC signal source.

14. The touch sensing method according to claim 8, wherein the at least two objects directly touch a touch panel without styluses.

15. A touch panel operating method for a vehicle cockpit system, comprising:
detecting a touch event of at least two objects occurring on a touch panel of the vehicle cockpit system;
analyzing a signal characteristic corresponding to the touch event;
distinguishing touch operations of the at least two objects according to the signal characteristic, wherein the touch event of at least two objects indicates the at least two objects touch the touch panel at a same time, wherein one of the at least two objects has a higher priority of operation; and
displaying items according to the priority of operation corresponding to the objects, which would not affect driving safety, on the touch panel when the touch event is performed by the objects.
